(19) United States
(12) Patent Application Publication
(10) Pub. No.: US 2024/0379130 A1
(43) Pub. Date: Nov. 14, 2024

(54) SIGNAL PROCESSING DEVICE AND SIGNAL PROCESSING METHOD

(71) Applicant: YAMAHA CORPORATION, Hamamatsu-shi (JP)

(72) Inventors: Masakazu KATO, Hamamatsu-shi (JP); Yuji MIURA, Hamamatsu-shi (JP); Keizo HARADA, Hamamatsu-shi (JP)

(21) Appl. No.: 18/777,936

(22) Filed: Jul. 19, 2024

Related U.S. Application Data
(63) Continuation of application No. PCT/JP2022/040599, filed on Oct. 31, 2022.

(30) Foreign Application Priority Data
Jan. 20, 2022 (JP) 2022-007337

(51) Int. Cl. G11B 27/031; G06V 10/77; G06V 40/18; G06V 40/20; G10H 1/00

(52) U.S. Cl. CPC G11B 27/031; G06V 10/77; G06V 40/18; G06V 40/20; G10H 1/0008; G10H 2210/056; G10H 2210/071

(57) ABSTRACT

A signal processor includes an image obtainer, an estimator, and an outputter. The image obtainer obtains a performance image including playing of a drum. The estimator estimates a degree of attention attracted by the playing of the drum included in the performance image by inputting the performance image into a learning model. The learning model has been subjected to machine learning to estimate the degree of attention based on a feature quantity related to the playing of the drum. The outputter outputs the degree of attention estimated by the estimator.

### CROSS-REFERENCE TO RELATED APPLICATIONS

The present application is a continuation application of International Application No. PCT/JP2022/040599, filed Oct. 31, 2022, which claims priority to Japanese Patent Application No. 2022-007337, filed Jan. 20, 2022. The contents of these applications are incorporated herein by reference in their entirety.

The present disclosure relates to a signal processor and a method of processing a signal.

On video sharing platforms (video hosting services), users can freely post video images, and audiences can view the posted video images. Some users gain attention from a large number of viewers by posting video images, and there is a need to create video images that will gain attention from viewers. JP2004-127019A discloses a technique of detecting an exciting part of music from music information. For example, there may be a case that a user posts a video image of a band playing a song. Using the aforementioned technology, the video image can be edited to include images corresponding to the exciting parts of the song, creating captivating content that will attract and maintain viewers' attention.

When focusing on the individual instruments within the band, however, the phrases that make the song exciting may not always coincide with the most captivating phrases. For example, a drum fill-in, which is played in a phrase leading up to the song's build-up, might occur at a different moment than the song's climax, yet still attract significant attention on that instrument. To determine if a performance on a particular instrument is attracting significant attention, the video editor must possess knowledge and experience of the performance. It is desirable to detect a performance scene that attracts significant attention as an image that also conveys strong interest, even if the performance scene occurs in phrases distinct from the song's most exciting moments.

The present disclosure has been made in view of the aforementioned circumstances, and has an object to provide: a signal processor that estimates the level of attention in a performance depicted in an image; and a method of processing a signal such that the method estimates the level of attention in a performance depicted in an image.

### SUMMARY

One aspect is a signal processor including an image obtainer, an estimator, and an outputter. The image obtainer is configured to obtain a performance image including playing of a drum. The estimator is configured to estimate a degree of attention attracted by the playing of the drum included in the performance image by inputting the performance image into a learning model. The learning model has been subjected to machine learning to estimate the degree of attention based on a feature quantity related to the playing of the drum. The outputter is configured to output the degree of attention estimated by the estimator.

Another aspect is a signal processor including an image obtainer, an estimator, and an outputter. The image obtainer is configured to obtain a performance image including playing of a drum. The estimator is configured to estimate a degree of attention attracted by the playing of the drum included in the performance image based on a feature quantity related to the playing of the drum. The outputter is configured to output the degree of attention estimated by the estimator.

Another aspect is a method of processing a signal. The method includes obtaining a performance image including playing of a drum. The method also includes estimating a degree of attention attracted by the playing of the drum included in the performance image based on a feature quantity related to the playing of the drum. The method also includes outputting the estimated degree of attention.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram illustrating an example configuration of a signal processing system 1 according to an embodiment;

FIG. 2 is a block diagram illustrating an example configuration of the user terminal 10 according to the embodiment;

FIG. 3 is a block diagram illustrating an example configuration of a signal processor 20 according to the embodiment;

FIG. 4 is a schematic illustration of an example of image information 220 according to the embodiment;

FIG. 5 is a schematic illustration of an example of the musical score information 221 according to the embodiment;

FIG. 6 is a schematic illustration of processing performed by an editor 232 according to the embodiment;

FIG. 7 is a schematic illustration of an example of how to determine the degree of attention from an image according to the embodiment;

FIG. 8 is a schematic illustration of an example of how to determine the degree of attention from performance sound according to the embodiment; and

FIG. 9 is a sequence diagram illustrating a flow of processing performed by the signal processing system 1 according to the embodiment.

### DESCRIPTION OF THE EMBODIMENTS

The present specification is applicable to a signal processor and a method of processing a signal.

Embodiments of the present disclosure will be described below by referring to the accompanying drawings.

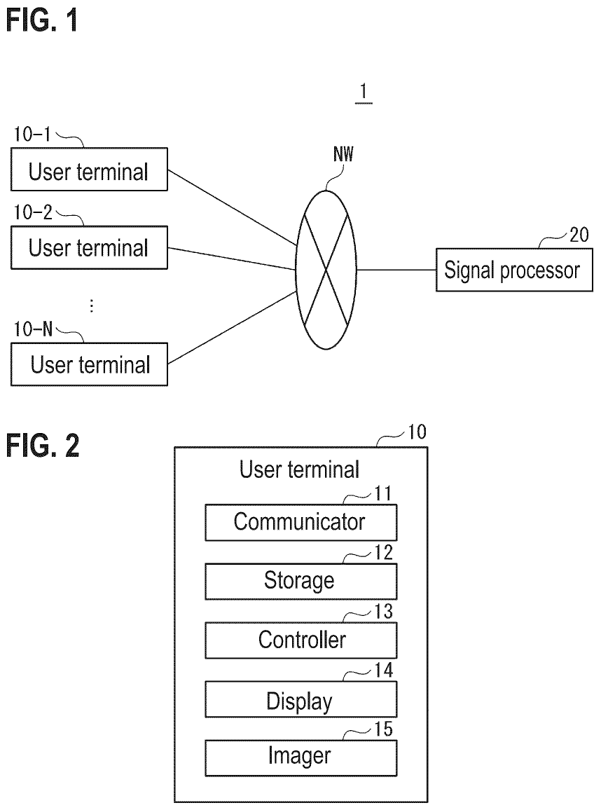

The signal processing system 1 according to an embodiment is a system that detects an image attracting a high degree of attention from a video image (hereinafter referred to as performance video) showing a musical performance (hereinafter referred to as performance). FIG. 1 is a block diagram illustrating an example configuration of the signal processing system 1. The signal processing system 1 includes the signal processor 20 and a plurality of user terminals 10 (the user terminals 10-1, 10-2, . . . , 10-N; N is any natural number). The signal processor 20 is communicatively connected to each of the plurality of user terminals 10 via a communication network NW.

Each user terminal 10 is a computer such as a PC (Personal Computer), a tablet terminal, and a smartphone. The user terminal 10 obtains a performance video taken by a user. The user terminal 10 transmits the obtained performance video to the signal processor 20.

The signal processor 20 is a computer such as a server device and a PC. The signal processor 20 receives a performance video from a user terminal 10. Then, the signal processor 2 estimates the degree of attention attracted by each of images (hereinafter referred to as performance image) included in the received performance video to obtain an estimation result. Then, the signal processor 20 transmits the estimation result to the user terminal 10. The signal processor 20 may edit the performance video based on the estimation result, and transmit the edited performance video to the user terminal 10.

As used herein, the term “degree of attention” attracted by an image is intended to mean the extent to which the image attracts a viewer's attention. For example, in a case that a viewer shows a high degree of attention to a performer's act, an image of the performer's act is an image attracting a high degree of attention. The degree of attention may also be the extent to which a performance sound associated with the performance video attracts the attention of a listener. For example, if a performer's act is monotonous and does not capture much attention from the viewer, but the listener is greatly interested in the sound of the performance, then an image of the performer's act is an image attracting a high degree of attention.

The following description is an example in which the performance video includes playing of a drum so that a drum playing attracting a high degree of attention is detected from the performance video. An image of the playing of the drum included in the performance video may include at least one of a drum set or a drummer of the drum set (drummer); that is, the image of the playing of the drum may not necessarily include both the drum set and the drummer. For example, at least one of the images constituting the performance video may include at least a part of the drum set, or at least another one of the images constituting the performance video may include at least a part of the body of the drummer (such as the drummer's face or arm). For further example, a drum sound may be included in a sound correlated with the performance video.

FIG. 2 is a block diagram illustrating an example configuration of each user terminal 10. The user terminal 10 includes a communicator 11, a storage 12, a controller 13, a display 14, and an imager 15. The communicator 11 communicates with the signal processor 20. The communicator 11 transmits a performance video taken by the user to the signal processor 20.

The storage 12 is a storage medium such as an HDD, a flash memory, an EEPROM (Electrically Erasable Programmable Read Only Memory), a RAM (Random Access read/write Memory), and a ROM (Read Only Memory). Alternatively, the storage 12 may be implemented by a combination of these storage media. The storage 12 stores programs for performing various kinds of processing of the user terminal 10. The storage 12 also stores temporary data used in various kinds of processing.

The user terminal 10 includes a CPU (Central Processing Unit), in the form of hardware. The controller 13 controls the CPU to execute the programs stored in the storage 12 to implement the functions of the controller 13. The controller 13 integrally controls the user terminal 10. The controller 13 individually controls the communicator 11, the storage 12, the display 14, and the imager 15.

The display 14 includes a display device such as a liquid crystal display to display still images and video images under the control of the controller 13. The imager 15 includes an image pick-up device to take a performance video under the control of the controller 13.

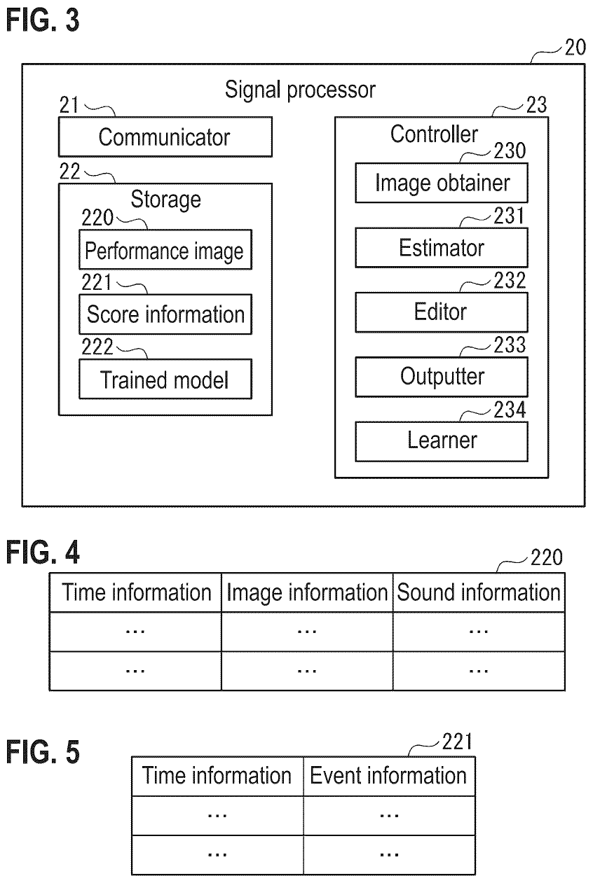

FIG. 3 is a block diagram illustrating an example configuration of the signal processor 20. The signal processor 20 includes a communicator 21, the storage 22, and a controller 23. The communicator 21 communicates with the user terminal 10. The communicator 21 receives a performance video from the user terminal 10.

The storage 22 is a storage medium such as an HDD, a flash memory, an EEPROM, a RAM, and a ROM. Alternatively, the storage 22 may be implemented by a combination of these storage media. The storage 22 stores programs for performing various kinds of processing of the signal processor 20. The storage 22 also stores temporary data used in various kinds of processing.

The storage 22 stores the image information 220, the musical score information 221, and a trained model 222. The image information 220 is information indicating a performance video. The musical score information 221 is information indicating a musical score of a piece of music performed in the performance video. The trained model 222 is information indicating a trained model used by an estimator 231, described later, in estimation processing. The trained model 222 stores information used in model construction. For example, there may be a case that the trained model 222 is a model based on a DNN (Deep Neural Network). In this case, the information used in model construction and stored in the trained model 222 indicates the unit number of each of an input layer, an intermediate layer, and an output layer; the layer number of intermediate layers; a coupling coefficient between the units; a bias value for each unit; and an activation function for each unit.

FIG. 4 is a schematic illustration of an example of the image information 220. The image information 220 stores pieces of information respectively corresponding to items, namely, time information, image information, and sound information. The time information is information indicating a passage of time based on a predetermined time point such as when the user started taking a performance video. The image information is information indicating the performance image taken at the time point identified by the time information. The sound information is information indicating a performance sound played at the time point identified by the time information. The performance sound includes a sound of a musical instrument played by a performer, a vocal sound, a special effect sound, and a sound sampled in advance.

FIG. 5 is a schematic illustration of an example of the musical score information 221. The musical score information 221 stores pieces of information respectively corresponding to items, namely, time information and event information. The time information is information indicating a passage of time based on a predetermined time such as when a musical performance started. The event information is information indicating: a tone output at the time point identified by the time information; and the strength and length of the tone. The musical score information 221 may also include information, other than the time information and the event information, that indicates the title of the piece of music, the tempo of the piece of music, musical time, and lyrics. A MIDI (Musical Instrument Digital Interface) file may be used as the musical score information 221.

Referring again to FIG. 3, the controller 23 is implemented by controlling the CPU of the signal processor 20 to execute programs. The controller 23 integrally controls the signal processor 20. The controller 23 individually controls the communicator 21 and the storage 22.

The controller 23 includes an image obtainer 230, the estimator 231, the editor 232, an outputter 233, and a learner 234.

The image obtainer 230 obtains the performance video taken by the user via the communicator 21. The image obtainer 230 stores the obtained performance video in the storage 22 as image information 220.

The estimator 231 uses a trained model to estimate the degree of attention attracted by each image included in the performance video. The estimator 231 refers to the trained model 222 in the storage 22 to construct a trained model. The estimator 231 inputs the image into the constructed trained model. The trained model estimates the degree of attention attracted by the input image to output an estimation result. The estimator 231 sets the estimation result output from the trained model as the degree of attention attracted by the image.

The editor 232 edits the performance video. For example, the editor 232 edits a performance video based on its degree of attention. Specifically, when a performance image has a degree of attention higher than a threshold, the editor 232 enlarges the performance image by zooming the performance image to generate a video image using the enlarged image.

Alternatively, the editor 232 may generate a video image using a shortened performance video. For example, there may be a restriction on the size of video files posted on a video-sharing website. In this case, it is necessary to shorten the performance video to generate a video image with a file size suitable for posting. To address the file size restriction, the editor 232 generates a video image by shortening the performance video. Based on the degree of attention attracted by each performance image included in the performance video, the editor 232 selects a performance image attracting a higher degree of attention than the threshold. The editor 232 uses the selected performance image to generate a video image. For example, the editor 232 generates a video image in which performance images thus selected are aligned in chronological order. In this case, the editor 232 may select a performance image, from the performance images used for editing, that attracts a particularly high degree of attention. Then, the editor 232 may enlarge the selected performance image to generate a video image using the enlarged performance image.

It is to be noted that when the editor 232 selects a performance image attracting a higher degree of attention than the threshold, the editor 232 may select an image group that includes a target image attracting a higher degree of attention than the threshold and images coming before and after the target image. This ensures that the target image and the images coming before and after the target image are connected in chronological order when the images are on display. That is, it is possible to display images in a manner that ranges from images that attract low degrees of attention to images that attract high degrees of attention. This manner of displaying images can attract more attention from the viewer than when only the target image is displayed.

The editor 232 may also generate a single video image using a plurality of performance videos of drum playing taken from different directions.

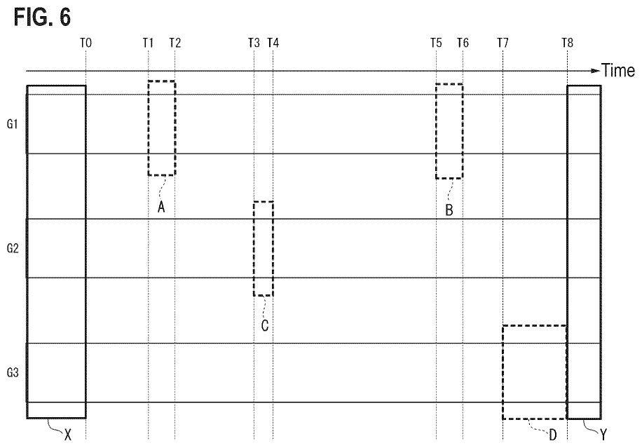

By referring to FIG. 6, description will be made with regard to how the editor 232 generates a single video image using a plurality of performance videos. FIG. 6 is a schematic illustration of processing performed by the editor 232. In FIG. 6, performance images included in a plurality of performance videos G (performance videos G1 to G3) are aligned in chronological order.

FIG. 6 is based on the assumption that the estimator 231 has the estimated degree of attention attracted by the performance image included in each performance video G. In the performance video G1, the image group (indicated by reference A) shown in time T1 to T2 and the image group (indicated by reference B) shown in time T5 to T6 are estimated as attracting a higher degree of attention than the threshold. In the performance video G2, the image group (indicated by reference C) shown in time T3 to T4 is estimated as attracting a higher degree of attention than the threshold. In the performance video G3, the image group (indicated by reference D) shown in time 77 to T8 is estimated as attracting a higher degree of attention than the threshold. Also in the example illustrated in FIG. 6, the images (indicated by reference X) at or before time T0 and at or after time 78 are determined as showing no performance, and are correlated with a degree of attention indicating substantially no attention (for example, a minimum value).

From each performance video G, the editor 232 identifies performance images taken at an identical time. For example, the editor 232 identifies performance images taken at an identical time based on commonality found in the performance sounds correlated with each performance video G. Alternatively, the editor 232 may identify performance images taken at an identical time based on a time code set to each performance video G.

The editor 232 selects a performance image attracting a higher degree of attention than the threshold based on the degree of attention attracted by each performance image included in the performance video. Specifically, the editor 232 selects image groups corresponding to references A to D. The editor 232 generates a video image in which the selected image groups are aligned in chronological order. For example, the editor 232 generates a video image in which the image groups are aligned in the order of reference A, reference B, reference C, and reference D. In this case, the editor 232 may enlarge one of the performance images constituting the video image in a case that the one of the performance images is attracting a particularly high degree of attention. Then, the editor 232 may generate a video image using the enlarged performance image.

The outputter 233 outputs the estimation result estimated by the estimator 231. That is, the outputter 233 outputs the estimated degree of attention attracted by each performance image. Alternatively, the outputter 233 may output the video image edited by the editor 232. This information output from the outputter 233 is transmitted to the user terminal 10 via the communicator 21.

Which information is to be output from the outputter 233 is determined based on the user's demand. For example, there may be a case that the user edits the performance video based on an estimated degree of attention attracted by a performance image. In this case, the outputter 233 outputs the estimated degree of attention attracted by the performance image. In contrast, there may be a case that the user requests the signal processor 20 to edit a performance image. In this case, the outputter 233 outputs the performance video edited by the editor 232.

The outputter 233 may also output information that enables the user to edit the performance video using an image with a high attention point. For example, to the user terminal 10, the outputter 233 outputs information for sorting performance videos taken by a plurality of cameras based on the degree of attention and displaying the sorted performance videos. For example, the user terminal 10 shows, on its display screen, a plurality of performance videos such that performance videos attracting higher degrees of attention are displayed at upper-level positions and performance videos attracting lower degrees of attention are displayed at lower-level positions. This enables the user to view the images in order from top to bottom and select a high attention degree image for editing without having to view all the images.

Alternatively, the outputter 233 may extract a part of the video that corresponds to the time length specified by the user and that has a relatively high degree of attention. Then the outputter 233 may provide information regarding the extracted part of the video to the user terminal 10. This makes it possible to suggest video parts of just the right length that are of high interest to the user and that match the time tone specified by the user.

Alternatively, the outputter 233 may output information to the user terminal 10 as an estimation result, showing a thumbnail image with a specially high attention point. This enables the outputter 233 to suggest an image with a high attention point in a manner that is easy for the user to understand.

Alternatively, the outputter 233 may generate a thumbnail using an image with a high attention point and allow the user's account to post the generated thumbnail on a social networking service (SNS). In this case, for example, the outputter 233 generates a thumbnail using an image with a high attention point. When the outputter 233 transmits the generated thumbnail to the user terminal 10, the outputter 233 also transmits information indicating a button labeled “Post” along with the thumbnail. As a result, along with the thumbnail, a button labeled “Post” appears on the display screen of the user terminal 10. The user views the thumbnail and operates the button when the user posts the thumbnail on the SNS. Upon performance of the touch operation, the user terminal 10 obtains information corresponding to the touch operation and transmits the information to the signal processor 20. Based on the information received from the user terminal 10, the signal processor 20 posts the thumbnail on the SNS using the user's account registered in advance.

The learner 234 generates a trained model. The trained model is a machine learning model that has been trained using a learning dataset to output the degree of attention for an input image. In this example, the model is a DNN. However, the model is not limited to DNN and may include other learning models such as CNN (Convolutional Neural Network), RNN (Recurrent Neural Network), a combination of CNN and RNN, HMM (Hidden Markov Model), SVM (Support Vector Machine), or any other learning model.

In this embodiment, the learning dataset is information that includes combination of learning images and degrees of attention of the learning images. The learning images are included in unspecified performance videos of band acts performed in the past. The learning images include a drum playing. Some of the learning images include a drum playing attracting a high degree of attention from viewers, while other of the learning images include a drum playing attracting a relatively low degree of attention. Thus, there is a correlation between a learning image and the degree of attention. The learning model is trained to learn this correlation to prepare a trained model. This trained model is able to estimate the degree of attention attracted by an image. For example, learning images are each assigned a degree of attention by an expert who views that image. In this manner, the learning dataset is generated. As used in the present disclosure, the term “expert” is intended to mean a person who has extensive experience in drum playing and video editing or video viewing related to drum playing, that is, a person who is familiar with scenes of interest in drum playing. Using such expert ensures generating a learning dataset in which learning images are correlated with appropriate degrees of attention. This ensures that even a user without knowledge or experience in performance can understand when a high degree of attention is given to a phrase outside the song's exciting part. This is achieved by utilizing the trained model that has learned from the dataset in which learning images are correlated with appropriate degrees of attention. This allows the user to recognize that a high degree attention is being applied to a phrase other than the song's exciting part.

The learner 234 causes the model to learn the correlation between the learning images and the degrees of attention included in the learning dataset. In a case that model is built using a DNN, the learner 234 sets parameters of the model (for example, a coupling coefficient between the units and a bias value for each unit) to ensure that upon input of a learning image included in the learning dataset, the model is able to output the degree of attention correlated with the input learning image. The learner 234 performs this setting until the parameters become suitable to ensure that the degrees of attention are accurately output for all the learning images included in the learning dataset. Then, the learner 234 sets this model as a trained model. By determining suitable parameters based on the correlation indicated by the learning dataset, the trained model is able to accurately estimate the degree of attention attracted by an image. The learner 234 stores information indicating the generated trained model in the storage 22 as image information 220.

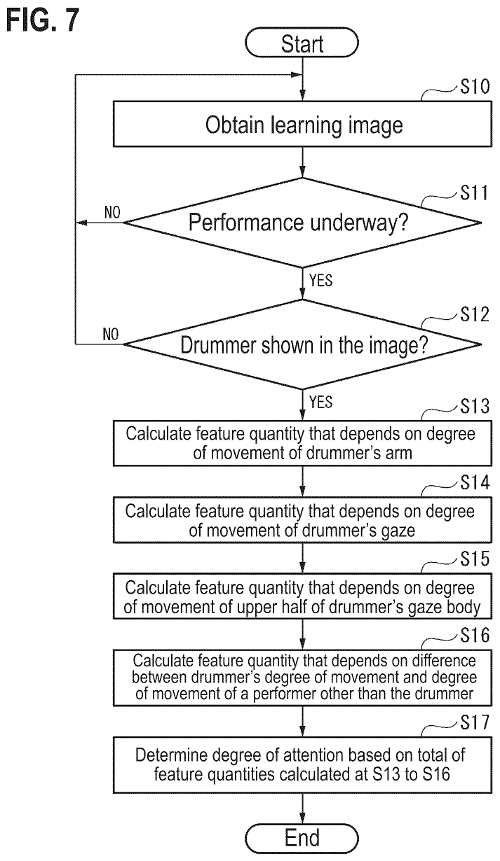

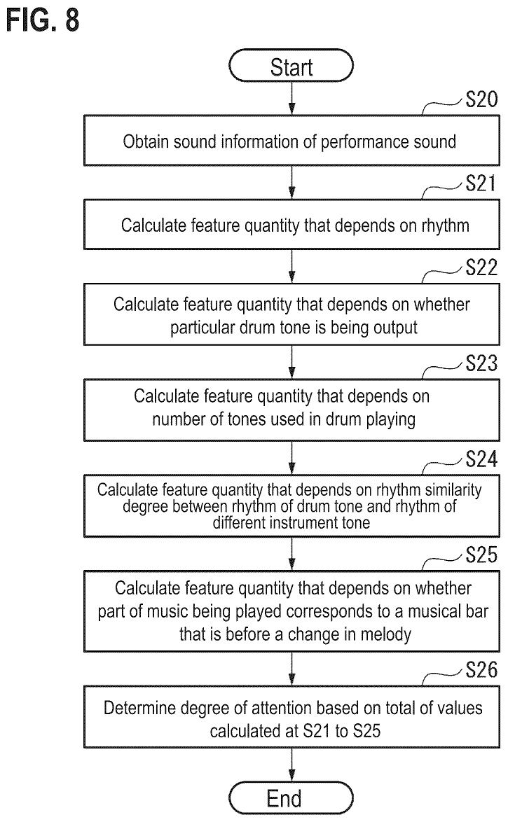

By referring to FIGS. 7 and 8, description will be made with regard to how to determine the degree of attention attracted by a learning image. FIG. 7 is a schematic illustration of an example of how to determine the degree of attention attracted by an image based on a performer's movement in the image. FIG. 8 is a schematic illustration of an example of how to determine the degree of attention attracted by an image from performance sound correlated with the image. The processings of determining the degree of attention illustrated in FIGS. 7 and 8 may be performed by a human being such as an expert, or may be performed by the learner 234 using a technique such as image processing. The following description is a case that the learner 234 performs the processing of determining the degree of attention.

In the learning dataset, a degree of attention is correlated with a learning image such that, for example, the degree of attention is based on a feature quantity that depends on a movement of a drummer shown in the learning image. That is, a feature quantity that depends on a movement of the drummer shown in the learning image is calculated, and a degree of attention is determined based on the calculated feature quantity. The feature quantity that depends on a movement of the drummer is an example of the “feature quantity related to the playing of the drum”.

For example, in a case that the drummer is beating a monotonous rhythm, the drummer's arms keep a repetitive, mechanical motion. In a case of a show-stopping performance where full strokes of the drumsticks are used, the drummer's arm movements are more pronounced compared with the drummer's arm movements in a monotonous rhythmic performance. By using the degree of the drummer's arm movements as a feature quantity to determine the degree of attention, a scene where the drummer performs with wide, expressive arm motions is detected as an image attracting a high degree of attention.

For example, in a case that the drum is beating a monotonous rhythm, the drummer's gaze (line of sight) remains steady on the drum set, specifically on the drums or cymbals being played, with minimal movement. In contrast, when the drummer “locks in (syncs up)” with other performers, the drummer shifts the drummer's gaze from the instrument being played to make eye contact with the other performers, ensuring precise timing synchronization. Additionally, when the drummer performs a “break”, where a player stops playing in coordination with the other performers, the drummer shifts the drummer's gaze from the drum or cymbal being played to make eye contact with the other performers, ensuring synchronized timing. Thus, during “locking in”, “break”, and other high-profile performances, the drummer's gaze often shifts away from the instrument that the drummer is playing to coordinate with the other performers. In light of this tendency in drum playing, the degree of attention is determined by using the direction of the drummer's gaze as a feature quantity. For example, a feature quantity is calculated such that the degree of attention is low when the drummer's gaze is directed at the instrument being played, and high when the gaze is directed at other than the instrument being played. By using the direction of the drummer's gaze as a feature quantity to determine the degree of attention, a scene where the drummer performs “locking-in” or a “break” is detected as an image attracting a high degree of attention.

For example, while the drum is beating a monotonous rhythm, the drummer moves less than the other performers. In contrast, during a drum solo performance, only the drummer is active, with no movement from the other performers. By using the difference between the drummer's movement and the movements of the other performers as a quantity to determine the degree of attention, a scene where the drummer performs a solo is detected as an image attracting a high attention level.

For example, in a case that the drum is beating a monotonous rhythm, the drummer's arms do move, but the drummer remains seated with little movement in the drummer's upper body except for the arms. In contrast, the drummer's upper body posture changes when adding fill-ins to enhance a song or when playing specific instruments such as a wind chime and a tambourine. For example, a drummer may change the orientation of the drummer's upper body to play a particular instrument or strike multiple cymbals. Alternatively, if the drummer joins a chorus, the drummer moves toward the microphone to sing. By comparing the degrees of the drummer's upper body movements, a scene where the drummer performs a special act, a flashy performance such as stick twirling, and a solo performance is detected as an image attracting a high degree of attention.

Thus, by focusing on the performer's movements, an appropriate degree of attention is determined. FIG. 7 illustrates processing of calculating a feature quantity that depends on the presence or absence of the performer's movement, among other factors; and processing of correlating the calculated feature quantity with a degree of attention.

As illustrated in FIG. 7, the learner 234 obtains a learning image (step S10). The learner 234 determines whether the obtained image indicates that a performance is underway (step S11). For example, the learner 234 determines whether the obtained image indicates that a performance is underway based on the presence and absence of a performance sound correlated with the obtained image. Alternatively, the learner 234 may determine whether the obtained image indicates that a performance is underway based on whether the performer shown in the obtained image is making a movement indicating the performance. In determining whether a performance is underway, it is possible to use not only the target image but also images coming before and after the target image in chronological order. For example, there may be a case that a relatively long break is inserted during a performance, with all the band members ceasing movement, followed by silence. Following a relatively long break of this nature, the performer starts moving again, and the performance sound resumes. In this case, the target image is determined as “underway”.

In a case that the obtained image indicates “underway”, the learner 234 determines whether the drummer is shown in the obtained image (step S12). For example, the learner 234 determines whether the drummer is shown in the obtained image by identifying a person shown in the obtained image using an image recognition technique.

In a case that the drummer is shown in the obtained image, the learner 234 calculates the degree of movement of the drummer's arm (step S13). The learner 234 calculates the degree of movement of the drummer's arm based on the amount of change in each of continuous frame images. For example, the learner 234 calculates the degree of movement of the drummer's arm based on the difference between the position of the drummer's arm in the current frame image and the position of the drummer's arm in the immediately preceding frame image. In a case of a great difference, the learner 234 determines that the degree of movement of the drummer's arm is high. In a case of a small difference, the learner 234 determines that the degree of movement of the drummer's arm is small.

Next, the learner 234 calculates the degree of movement of the drummer's gaze (step S14). For example, in a case that the direction of the drummer's gaze coincides with the direction of the drum set, the learner 234 determines that the degree of movement of the drummer's gaze is small. In a case that the direction of the drummer's gaze is different from the direction of the drum set, the learner 234 determines that the degree of movement of the drummer's gaze is high.

Next, the learner 234 calculates the degree of movement of the upper half of the body of the drummer (step S15). For example, the learner 234 uses a method similar to the method of calculating the degree of movement of the drummer's arm to calculate the degree of movement of the upper half of the body of the drummer.

Next, the learner 234 calculates a difference between the degree of movement of the drummer and the degree of movement of a second performer other than the drummer (step S16). For example, the learner 234 uses a method similar to the method of calculating the degree of movement of the drummer's arm to calculate the degree of movement of the drummer and the degree of movement of the second performer. The learner 234 calculates the difference between the obtained degrees of movement. In a case that the degree of movement of the drummer is higher than the degree of movement of the second performer, the learner 234 sets the difference greater.

At step S17, the learner 234 determines the degree of attention based on a total of feature quantities calculated at steps S13 to S16. Specifically, for example, a high degree of attention may be correlated with a scene in the learning image where the drummer's arm movement is high. For another example, a high degree of attention may be correlated with a scene in the learning image where the drummer's gaze is directed in a direction different from the direction of the drum set. For another example, a high degree of attention may be correlated with a scene in the learning image where the movement of the upper half of the body of the drummer is high. For another example, a high degree of attention may be correlated with a scene in the learning image where the other performers than the drummer are making no movement, that is, a scene in the learning image where the drummer is playing a solo performance. It is also possible to combine these examples. Specifically, a high degree of attention may be correlated with a scene in the learning image where the drummer makes large, dramatic movements with the drummer's arms and upper body, particularly during a special or showy performance, or a solo performance.

There may be a case at step S11 that the image is determined as not “underway”, or there may be a case at step S12 that the drummer is determined as not shown in the image. In these cases, these images are correlated with a degree of attention indicating substantially no attention (for example, a minimum value).

While in the above description steps S13 to S16 are performed in this order, steps S13 to S16 may be performed in any other order. It is also possible to perform at least one of steps S13 to S16.

Also in the learning dataset, a degree of attention is correlated with a learning image such that the degree of attention is based on a feature quantity obtained from a performance sound corresponding to the learning image.

A feature quantity obtained from a performance sound may be a feature quantity that depends on rhythm. For example, the rhythm varies among a case that the drum is beating a monotonous rhythm, a case of a drum fill-in, and a case of “locking in”. By determining the degree of attention based on a rhythm-based feature quantity, a scene where the piece of music is played at a rhythm different from a monotonous rhythm is detected as an image attracting a high degree of attention.

A feature quantity obtained from a performance sound may be a feature quantity that depends on the number of tones. For example, in a case that the drum is beating a monotonous rhythm, a particular instrument such as a snare drum, a bass drum, or hi-hat cymbals is often played. In this case, the tone produced by at least one of these particular instruments is output. In contrast, in a case that the piece of music is enlivened, a different tone is output than when the rhythm is monotonous. For example, a crash cymbal sound is added, a wind chime or tambourine sound is added, or the sound transitions from a snare drum to a tom. For another example, there may be a case that hi-hat cymbals are in open state, or a ride cymbal is beat instead of the hi-hat cymbals. For another example, there may be a case that a special effect sound is output. By determining the degree of attention based on a feature quantity that depends on the number of tones, a scene where a crash cymbal sound is added is detected as an image attracting a high degree of attention.

A feature quantity obtained from a performance sound may be a feature quantity that depends on sound volume. For example, in a case of a full-stroke drumstick, a larger sound volume is output than the sound volume in a case of a monotonous rhythm. By determining the degree of attention based on a feature quantity that depends on sound volume, a scene where a larger sound volume is output than the sound volume in a case of a monotonous rhythm is detected as an image attracting a high degree of attention.

A feature quantity obtained from a performance sound may be a feature quantity that depends on a musical score. For example, a drum fill-in is often played at a moment immediately before a melody change to A melody, B melody, or a hook. Some musical scores indicate a musical bar (measure) for inserting a drum fill-in. Additionally, the musical score allows for determining whether a bar features a monotonous rhythm or varies between fast and slow rhythms. By determining the degree of attention based on a feature quantity that depends on a musical score, a scene where a drum fill-in is estimated to be inserted or a scene where the piece of music is played at a rhythm different from a monotonous rhythm is detected as an image attracting a high degree of attention.

Thus, by calculating a feature quantity that depends on a performance sound, an appropriate degree of attention is determined. FIG. 8 illustrates a flow of processing of determining the degree of attention based on a feature quantity that depends on a performance sound.

As illustrated in FIG. 8, the learner 234 obtains sound information and musical score information that are of a performance sound produced in a training performance video (step S20). An example of the sound information is information of a sound collected by a microphone during recording of the performance video. An example of the musical score information is information corresponding to the performance sound.

Based on the obtained sound information, the learner 234 calculates a feature quantity that depends on the rhythm at which the piece of music is played (step S21). For example, the learner 234 determines whether a drum tone is included in sound information for each predetermined time, for example, time corresponding to each bar in the musical score. The determination as to whether a drum tone is included in the sound information may be performed based on, for example, a sound frequency response included in the sound information. The sound frequency response can be calculated by subjecting the sound information to frequency conversion. The learner 234 determines the rhythm based on the number of drum tones output within a predetermined time. Alternatively, the learner 234 may determine the rhythm based on the number of musical notes for each bar dictated on the musical score. The learner 234 identifies the most frequently occurring rhythm in the entire piece of music as a reference, and calculates a feature quantity such that a rhythm different from the reference is assigned a high degree of attention.

The learner 234 calculates a feature quantity that depends on whether a particular drum tone is being output (step S22). For example, the learner 234 determines a tone output based on a sound frequency response included in the sound information. The learner 234 calculates a feature quantity that lowers the degree of attention in a case that the tone being output is a tone of a monotonous rhythm, such as a tone produced by a snare drum, a bass drum, or hi-hat cymbals. In contrast, the learner 234 calculates a feature quantity that increases the degree of attention in a case that the tone being output enlivens the music piece of music, such as a tone produced by a crash cymbal, a ride cymbal, hi-hat cymbals in open state, a tambourine, or a wind chime.

Incidentally, different drummers may vary in their choice of instruments for creating a monotonous rhythm and for enlivening a piece of music. In light of this fact, the learner 234 may determine the tone to be used for a monotonous rhythm and the tone to be used for enlivening a piece of music separately for each note played. For example, the learner 234 calculates a feature quantity that lowers the degree of attention for a tone output more frequently in the entire piece of music. The learner 234 calculates a feature quantity that increases the degree of attention for a tone used only a few times in the entire piece of music.

The learner 234 calculates a feature quantity that depends on the number of tones used in drum playing (step S23). For example, the learner 234 uses a method similar to the method used at step S21 to determine whether a drum tone is included in sound information for each predetermined time, for example, time corresponding to each bar in the musical score. The learner 234 determines the number of drum tones output within a predetermined time. The learner 234 calculates a feature quantity that increases the degree of attention for a larger number of drum tones.

The learner 234 calculates a feature quantity that depends on a rhythm similarity degree that is a degree of similarity between a rhythm of a drum tone and a rhythm of a tone produced by an instrument other than the drum, such as a guitar, a base, and a keyboard (step S24). For example, the learner 234 uses a method similar to the method used at step S21 to determine whether a drum tone or a tone produced by an instrument other than the drum is included in sound information for each predetermined time, for example, time corresponding to each bar in the musical score. The learner 234 calculates a rhythm of the drum tone and a rhythm of the tone produced by the instrument other than the drum for a time section that includes both the drum tone and the tone produced by the instrument other than the drum. Each rhythm may be calculated by a method similar to the method used at step S21. In a case that the rhythm of the drum tone and the rhythm of the tone produced by the instrument other than the drum agree, the learner 234 calculates a feature quantity that increases the degree of attention. This ensures that a feature quantity that increases the degree of attention can be calculated when the drummer “locks in (syncs up)” with the player of the other instrument, that is, when the drummer and the player of the other instrument play the same rhythm at the same time. In contrast, in a case that the rhythm of the drum tone and the rhythm of the tone produced by the other instrument do not agree, the learner 234 calculates a feature quantity that lowers the degree of attention.

The learner 234 refers to musical score information to calculate a feature quantity that depends on whether a part of music being played corresponds to a musical bar that is before a change in melody (step S25). The learner 234 determines a melody for each bar based on the musical score information. For example, in a case that the musical score information indicates A melody, B melody, and a hook, the learner 234 determines melodies based on the A melody, the B melody, and the hook. Alternatively, the learner 234 may determine melodies using a conventional technique such as a technique recited in JP2004-127019A. The learner 234 extracts a bar that is before a change in melody, and calculates a feature quantity that increases the degree of attention for the part of the performance indicated by the extracted bar.

At step S26, the learner 234 determines a degree of attention that is based on a total of the values calculated at steps S21 to S25. There may be a case that the sound of the drum in the learning image has a rhythm different from a monotonous rhythm, such as a faster rhythm and an irregular rhythm. In this case, this scene in the learning image is correlated with a high degree of attention. For further example, there may be a case that a performance image shows a scene where a particular sound such as a wind chime sound is output. In this case, this scene in the learning image is correlated with a high degree of attention. For further example, there may be a case that a performance image shows a scene where gorgeous sound is output with the addition of a more cymbal tone and a tambourine tone. In this case, this scene in the learning image is correlated with a high degree of attention. For further example, there may be a case that a performance image shows a scene where a “locking-in” is performed. In this case, this scene in the learning image is correlated with a high degree of attention. For further example, there may be a case that a performance image shows a scene of a bar corresponding to the time before a change in melody, such as when a drum fill-in is estimated to be inserted. In this case, this scene in the learning image is correlated with a high degree of attention. For further example, there may be a case that a performance image shows a scene where these cases are combined; for example, a scene of a bar corresponding to the time before a change in melody and a drum fill-in inserted at a rhythm different from a monotonous rhythm. In this case, this scene in the learning image is correlated with a high degree of attention.

While in the above description steps S21 to S25 are performed in this order, steps S21 to S25 may be performed in any other order. It is also possible to perform at least one of steps S21 to S25.

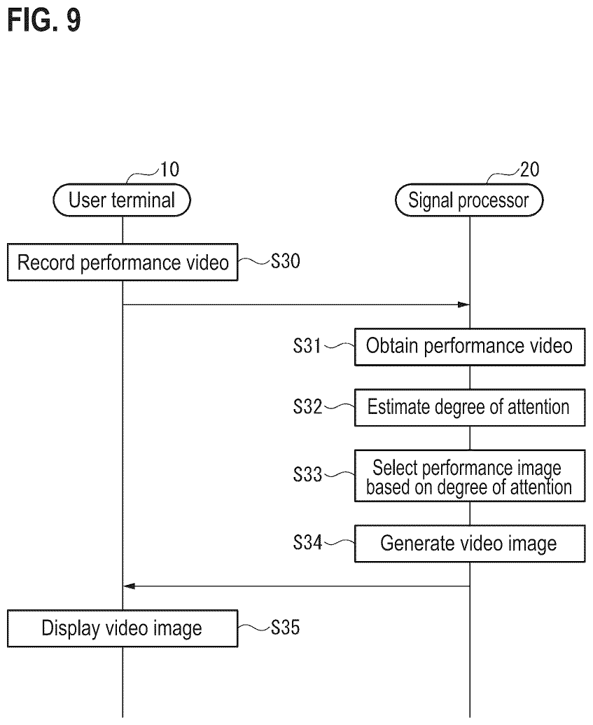

In this respect, a flow of the processing performed by the signal processing system 1 will be described by referring to FIG. 9. FIG. 9 is a sequence diagram illustrating a flow of the processing performed by the signal processing system 1.

The user terminal 10 records a performance video (step S30). The user terminal 10 transmits the recorded performance video to the signal processor 20.

The signal processor 20 obtains the performance video by receiving the performance video from the user terminal 10 (step S31). The signal processor 20 estimates the degree of attention attracted by each performance image included in the obtained performance video (step S32). Based on each degree of attention estimated, the signal processor 20 selects a performance image used for editing (step S33). The signal processor 20 generates a video image using the selected performance image (step S34). The signal processor 20 transmits the generated video image to the user terminal 10. The user terminal 10 displays the generated video image (step S35).

As has been described hereinbefore, the signal processor 20 according to this embodiment includes the image obtainer 230, the estimator 231, and the outputter 233. The image obtainer 230 obtains a performance image including playing of a drum. Based on a feature quantity obtained from the performance image, the estimator 231 estimates a degree of attention attracted by the playing of the drum shown in the performance image. The outputter 233 outputs the degree of attention estimated by the estimator 231. With this configuration, the signal processor 20 according to this embodiment is able to estimate the degree of attention attracted by the performance shown in the performance image.

Also in this embodiment, the estimator 231 of the signal processor 20 estimates the degree of attention using a trained model. The trained model is a model generated by subjecting a learning dataset to machine learning. The learning dataset correlates a learning image including the playing of the drum with the degree of attention attracted by the learning image. The trained model is a model trained to output a degree of attention for an input image. With this configuration, the signal processor 20 according to this embodiment is able to easily estimate the degree of attention using the trained model.

Also in the signal processor 20 according to this embodiment, the learning dataset is correlated with a degree of attention that is based on a feature quantity that depends on a movement of a drummer of the drum shown in the learning image. With this configuration of the signal processor 20 according to this embodiment, for example, a scene where the drummer plays a solo performance with wide motions of the drummer's arms and upper half body is correlated with a higher degree of attention.

Also in the signal processor 20 according to this embodiment, the learning dataset is correlated with a degree of attention that is based on a feature quantity that depends on whether a particular tone produced by the drum is included in a performance sound corresponding to the learning image. With this configuration of the signal processor 20 according to this embodiment, for example, a scene in the performance image where the piece of music is enlivened by a particular sound such as a wind chime sound is correlated with a high degree of attention.

Also in the signal processor 20 according to this embodiment, the learning dataset is correlated with a degree of attention that is based on a feature quantity that depends on the number of tones produced by the drum included in a performance sound corresponding to the learning image. With this configuration of the signal processor 20 according to this embodiment, a scene in the performance image where gorgeous sound is output with the addition of a more cymbal tone and a tambourine tone is correlated with a high degree of attention.

Also in the signal processor 20 according to this embodiment, the learning dataset is correlated with a degree of attention that is based on a feature quantity that depends on a similarity degree between: a performance sound output from a tone related to the drum and included in a performance sound corresponding to a learning image; and a performance sound output from a tone unrelated to the drum. With this configuration of the signal processor 20 according to this embodiment, a scene in the learning image where a “locking-in” is performed is correlated with a high degree of attention.

Also in the signal processor 20 according to this embodiment, the learning dataset is correlated with a degree of attention that is based on a feature quantity obtained from musical score information of the drum corresponding to the learning image. With this configuration of the signal processor 20 according to this embodiment, a scene of a bar corresponding to the time before a change in melody, such as when a drum fill-in is estimated to be inserted, is correlated with a high degree of attention.

The signal processor 20 according to this embodiment further includes the editor 232. The editor 232 generates a video image including a plurality of performance images. Based on a score that is based on the degree of attention estimated by the estimator 231, the editor 232 selects, from the plurality of performance images, an image having a score equal to or higher than a threshold. The estimator 231 uses the selected performance image to generate a video image. With this configuration, the signal processor 20 according to this embodiment is able to generate a video image including a performance image attracting a high degree of attention.

Also in the signal processor 20 according to an embodiment, the image obtainer 230 obtains a plurality of images of drum playing taken from different directions. The editor 232 identifies, from the plurality of performance images, performance images that were taken at an identical time. The editor 232 selects, from the identified performance images, a performance image having a score equal to or higher than the threshold. The editor 232 uses the selected performance image to generate a video image. This enables the signal processor 20 according to this embodiment to generate a video image that includes a performance image, among the plurality of performance images taken from different directions, that is attracting a high degree of attention.

In an embodiment, the estimator 231 (instead of the trained model) estimates a degree of attention using a rule-base model. This rule-base model derives a degree of attention from an image based on a predetermined rule group made by an expert. The rule group is correlated with a degree of attention that is based on a scene shown in the image. For example, a scene where the drummer performs with wide motions, a scene where the drummer inserts a drum fill-in, a scene where the drummer uses full strokes of the drumsticks, and a scene where the drummer plays a solo performance are correlated with a comparatively high degree of attention. In contrast, a scene where the drummer is beating a monotonous rhythm, a scene where a performance has not started yet, and a scene after a performance has ended are correlated with a comparatively low degree of attention.

The estimator 231 estimates the degree of attention attracted by a performance image using, for example, a method similar to the method by which the learner 234 determines the degree of attention. For example, the estimator 231 estimates the degree of attention based on the drummer's movement shown in the performance image. The estimator 231 estimates the degree of attention based on whether a particular drum tone is included in a performance sound performed in a performance video. The estimator 231 estimates the degree of attention based on the number of drum tones included in the performance sound. The estimator 231 estimates the degree of attention based on the similarity degree between: a performance sound output from a tone related to the drum and included in a performance sound corresponding to a learning image; and a performance sound output from a tone unrelated to the drum. In this embodiment, the degree of attention is estimated quantitatively according to a predetermined rule.

The estimator 231 may also estimate the degree of attention based on a feature quantity obtained from musical score information. In this case, the signal processor 20 obtains a performance video from the user terminal 10. Along with the performance video, the signal processor 20 also obtains musical score information of a piece of music played in the performance video. The estimator 231 estimates the degree of attention using the musical score information obtained by the signal processor 20. In this embodiment, the degree of attention is estimated using musical score information.

In the above-described embodiment, all the functions performed by the signal processing system 1 may be implemented by the signal processor 20. Then, the signal processor 20 may display the result of the processing performed by the signal processor 20, that is, the estimation result obtained by estimating the degree of attention. In this case, for example, the user terminal 10 takes a performance video, and transmits the taken performance video to the signal processor 20. The signal processor 20 estimate a degree of attention attracted by each performance image constituting the performance video received from the user terminal 10, and transmits the estimation result to the user terminal 10. The user terminal 10 receives the estimation result from the signal processor 20 and displays the received estimation result. In a case that this configuration is employed, it is not necessary for the user terminal 10 to store in its storage 12 the program of the processing of estimating the degree of attention. Instead, the program of the processing of estimating the degree of attention is stored in the storage 22 of the signal processor 20. In this case, the storage 12 of the user terminal 10 may be omitted.

The functions of the signal processing system 1 may be implemented by the signal processor 20 and a computer different from the signal processor 20. That is, one computer or a plurality of computers may perform the processing of estimating the degree of attention attracted by an image, which is a function of the signal processing system 1.

In an embodiment, the method of generating the trained model is a computer-implemented method. Specifically, the learner 234 generates a trained model by subjecting a learning model to machine learning to learn a learning dataset. The learning dataset is information that correlates a learning image including playing of the drum with the degree of attention attracted by the learning image.

Subjecting the trained model to machine learning to learn the learning dataset ensures that upon input of an image into the trained model, the trained model outputs the degree of attention in the input image. With this configuration, the signal processor 20 according to this embodiment is able to generate a trained model capable of estimating the degrees of attention of images.

In the above-described embodiment, a single computer (for example, the signal processor 20) performs the processing both in “learning stage” and “execution stage”. The term “learning stage” refers to a stage in which the learning model is trained to learn; specifically, the learner 234 generates a trained model. The term “execution stage” refers to a stage in which an estimation is made using the trained model; specifically, the estimator 231 estimates the degree of attention attracted by an image using the trained model. This configuration, however, is not intended in a limiting sense. The “learning stage” and the “execution stage” may be performed by different computers. For example, the “learning stage” may be performed by a learning server, which is a computer different from the signal processor 20. In this case, information regarding the trained model generated by the learning server may be transmitted to the signal processor 20. Then, this information is stored as trained model 222 in the storage 22 of the signal processor 20. Then, the signal processor 20 performs the processing in the “execution stage” by making an estimation using the trained model based on the trained model 222 stored in the storage 22.

The above-described embodiment ensures that the degree of attention attracted by a musical performance shown in an image is estimated. This enables the user to recognize the degree of attention in an image and respond based on the degree of attention in the image. For example, the user may select an image showing a musical performance with a high degree of attention.

The signal processing system 1 and the signal processor 20 according to the above-described embodiment may be entirely or partially implemented by a computer. In this case, programs for implementing the functions of the signal processing system 1 and the signal processor 20 may be recorded in a computer readable storage medium, and the programs recorded in the storage medium may be read into a computer system and executed in the computer system. As used herein, the term “computer system” is intended to encompass hardware such as OS (Operating System) and peripheral equipment. Also as used herein, the term “computer readable storage medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable storage medium” is intended to encompass: a medium that dynamically holds a program for a short period of time, a non-limiting example being a communications line through which a program is transmitted using a network such as the Internet or a telephone line; and a memory that holds a program for a predetermined period of time, a non-limiting example being a volatile memory built in a computer system serving as a client or a server in cases where a communications line is used as described above. It is also to be noted that the above-described program may be used to implement part of the above-described functions. It is further to be noted that the above-described program may be used to implement the above-described functions in combination with a program already recorded in the computer system. It is further to be noted that the above-described program may be implemented using a programmable logic device such as an FPGA (Field-Programmable Gate Array).

While some embodiments of the present disclosure have been described, these embodiments are intended as illustrative only and are not intended to limit the scope of the present disclosure. It will be understood that the present disclosure may be embodied in any other form without departing from the scope of the present disclosure, and that other omissions, substitutions, additions, and/or alterations may be made to the embodiments. Thus, these embodiments and modifications thereof are intended to be encompassed by the scope of the present disclosure as defined by the appended claims and their equivalents.

What is claimed is:

1. A signal processor comprising:
an image obtainer configured to obtain a performance image including playing of a drum;
an estimator configured to estimate a degree of attention attracted by the playing of the drum included in the performance image by inputting the performance image into a learning model, the learning model having been subjected to machine learning to estimate the degree of attention based on a feature quantity related to the playing of the drum; and
an outputter configured to output the degree of attention estimated by the estimator.

2. The signal processor according to claim 1, wherein
in the machine learning, the learning model has been trained to learn learning data correlated with the degree of attention, and
the degree of attention is based on a feature quantity that depends on a movement of a drummer of the drum shown in a learning image.

3. The signal processor according to claim 1, wherein
in the machine learning, the learning model has been trained to learn learning data correlated with the degree of attention, and
the degree of attention is based on a feature quantity that depends on whether a particular tone produced by the drum is included in a performance sound corresponding to a learning image.

4. The signal processor according to claim 1, wherein
in the machine learning, the learning model has been trained to learn learning data correlated with the degree of attention, and
the degree of attention is based on a feature quantity that depends on a number of tones produced by the drum included in a performance sound corresponding to a learning image.

5. The signal processor according to claim 1, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

6. The signal processor according to claim 1, wherein
in the machine learning, the learning model has been trained to learn learning data correlated with the degree of attention, and
the degree of attention is based on a feature quantity that depends on information indicating whether a part of music being played corresponds to a musical bar that is before a change in melody, the information being determined using musical score information corresponding to a learning image.

7. The signal processor according to claim 1, wherein
the performance image includes a plurality of performance images, and
the signal processor further comprises an editor configured to:
select, from the plurality of performance images, a performance image having a score equal to or higher than a threshold, the score being determined based on the degree of attention estimated by the estimator; and
generate a video image using the selected performance image.

8. The signal processor according to claim 7, wherein
the image obtainer is configured to obtain a plurality of images of the playing of the drum, and
the editor is configured to:
identify, from the plurality of performance images, performance images that were taken at an identical time;
select, from the identified performance images, a performance image having a score equal to or higher than the threshold; and
generate a video image using the selected performance image.

9. A signal processor comprising:
an image obtainer configured to obtain a performance image including playing of a drum;
an estimator configured to estimate a degree of attention attracted by the playing of the drum included in the performance image based on a feature quantity related to the playing of the drum; and
an outputter configured to output the degree of attention estimated by the estimator.

10. A method of processing a signal, the method comprising:
obtaining a performance image including playing of a drum;
estimating a degree of attention attracted by the playing of the drum included in the performance image based on a feature quantity related to the playing of the drum; and
outputting the estimated degree of attention.

11. The signal processor according to claim 2, wherein
in the machine learning, the learning model has been trained to learn learning data correlated with the degree of attention, and
the degree of attention is based on a feature quantity that depends on whether a particular tone produced by the drum is included in a performance sound corresponding to a learning image.

12. The signal processor according to claim 2, wherein
in the machine learning, the learning model has been trained to learn learning data correlated with the degree of attention, and
the degree of attention is based on a feature quantity that depends on a number of tones produced by the drum included in a performance sound corresponding to a learning image.

13. The signal processor according to claim 3, wherein
in the machine learning, the learning model has been trained to learn learning data correlated with the degree of attention, and
the degree of attention is based on a feature quantity that depends on a number of tones produced by the drum included in a performance sound corresponding to a learning image.

14. The signal processor according to claim 11, wherein
in the machine learning, the learning model has been trained to learn learning data correlated with the degree of attention, and
the degree of attention is based on a feature quantity that depends on a number of tones produced by the drum included in a performance sound corresponding to a learning image.

15. The signal processor according to claim 2, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

16. The signal processor according to claim 3, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

17. The signal processor according to claim 4, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

18. The signal processor according to claim 11, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

19. The signal processor according to claim 12, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.

20. The signal processor according to claim 13, wherein
in the machine learning, the learning model has been trained to learn learning data correlated with the degree of attention, and
the degree of attention is based on a feature quantity that depends on a rhythm similarity degree indicating how a rhythm of a tone produced by the drum included in a performance sound corresponding to a learning image is similar to a rhythm of a tone produced by a musical instrument different from the drum.
